(19) United States
(12) Patent Application Publication
(10) Pub. No.: US 2022/0169296 A1
(43) Pub. Date: Jun. 2, 2022

(54) STACKABLE CART

(71) Applicant: Tricam Industries, Inc., Eden Prairie, MN (US)

(72) Inventors: Benjamin M. Wernberg, Savage, MN (US); Joseph P. Foley, St. Paul, MN (US)

(21) Appl. No.: 17/538,979

(22) Filed: Nov. 30, 2021

Related U.S. Application Data
(60) Provisional application No. 63/119,315, filed on Nov. 30, 2020.

(51) Int. Cl. B62B 1/18; B62B 1/00

(52) U.S. Cl. CPC B62B 1/18; B62B 1/006

(57) ABSTRACT

A stackable cart with novel features is disclosed. The stacking cart allows for nesting of multiple fully assembled carts in opposite-facing directions to maximize density for storage and shipping, lowering the cost of storage and shipping, while minimizing parts and maximizing cart capacity.

### TECHNICAL FIELD

The present disclosure relates generally to a stackable cart that allows for nesting of fully assembled carts in opposite-facing directions to maximize density for storage and shipping, thus lowering the costs of storage and shipping.

### BACKGROUND

It is often desirable to transport cumbersome articles, through the use of a cart or wagon, from point A to point B that could not otherwise be easily transported by one or more individuals. Furthermore, it is desirable to transport and easily dump various types of particulate matter, such as dirt, loose gravel, and livestock feed as well as a multitude of other articles.

There are many forms of carts that have been used for carrying and dumping a variety of items. Many of which contain a relatively flat bed used to contain the articles in transit and a pivoting mechanism for slidably removing the articles from the bed to an alternate location.

Dumping carts are known, including those disclosed in U.S. Pat. No. 3,833,263 to Jackson; U.S. Pat. No. 4,711,499 to Fortin; U.S. Pat. No. 4,889,390 to Campbell; U.S. Pat. No. 5,395,163 to Mandell et al; U.S. Pat. No. 5,544,944 to Keech; and U.S. Pat. No. 6,290,301 to Bockman, all of which are incorporated herein by reference. Improvements over these earlier patents include U.S. Pat. No. 6,662,679 to Hobdy et al; U.S. Pat. No. 6,851,756 to Pieschel; U.S. Pat. No. 6,962,370 to Simpson; U.S. Pat. No. 7,175,205 to Simpson; U.S. Pat. No. 7,210,697 to Simpson; U.S. Pat. No. 7,390,065 to Pieschel et al; U.S. Pat. No. 7,441,792 to Simpson; U.S. Pat. No. 7,818,865 to Pieschel et al; U.S. Pat. No. 7,887,141 to Pieschel et al; U.S. Pat. No. D819,917 to Simpson et al; U.S. Pat. No. D826,507 to Wemberg et al., all of which are incorporated herein by reference.

Many prior art carts require assembly once purchased by a consumer because shipping completely fabricated carts would be extremely expensive due to the volume each cart would require for both shipping and for storage in retail outlets. To minimize the volume of each cart, the carts are packaged unassembled and require the user to assemble the cart before use.

One solution offered to address the issue of a stackable cart is presented by U.S. Pat. No. 6,848,695 to Panasewicz et al. The yard cart of Panasewicz et al. addresses the ability to stack fully-assembled yard carts. However, the yard cart of Panasewicz et al. has limited carrying volume in the transport position and the configuration of the yard cart requires significant reconfiguration between the transport, resting, and stacking positions. Additionally, while Panasewicz et al. addresses the ability to stack fully assembled carts, it does not address a configuration that maximizes shipping using standard shipping methods (standard 40-foot shipping containers typically have interior dimensions of 39′ 6″ long×7′ 6″ wide×7′ 10″ high).

### SUMMARY OF THE DISCLOSURE

A stackable cart of the present invention overcomes the deficiencies noted above. The disclosed and claimed concept provides for a fully-assembled cart that allows for the nesting of multiple carts to minimize the volume of the stacked carts. This stacking provides significant cost savings for transporting the carts and for storage of the carts.

In one embodiment of the invention, a stackable cart includes a tub and wheels rotatably attached to the tub. The tub includes a stand on the bottom with a lower extremity at the same level as the bottom of wheels. This configuration allows the cart to be level with the ground surface on which the cart is resting. The tub of the stackable cart is configured such that the wheels fit within a wheel cutout to allow the wheels to fit within the profile of the stackable cart. The interior dimensions of the stackable cart are such that the lower portion of the stackable cart can fit within another of the stackable carts. This arrangement allows one stackable cart to nest within another stackable cart and to stack multiple carts in a vertical manner. The tub and stand are configured to allow the stand of the nested cart to fit between the tires of the cart to which it is nested and the wheels of the nested cart fit within the tub width of the cart to which it is nested. This allows the nested carts to also be level while stacked without the need for additional packing materials to keep the carts in place.

From the foregoing disclosure and the following more detailed description of various preferred embodiments it will be apparent to those skilled in the art that the present invention provides a significant advance in the technology and art of carts. Particularly significant in this regard is the potential the invention affords for providing a high quality, reliable, low cost stackable assembly. Additional features and advantages of various preferred embodiments will be better understood in view of the detailed description provided below.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view of a stackable cart in accordance with an embodiment of the disclosure.

FIG. 2 is a left side elevation view of 13 stackable carts of FIG. 1.

FIG. 3 is a front elevation view of 13 stackable carts of FIG. 1.

FIG. 4 is a left side cutaway elevation view of 13 stackable carts of FIG. 1.

FIG. 5 is an arrangement of stacks of 13 stackable carts of FIG. 1 that would allow 38 stacks to be placed within a standard 40-foot shipping container.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

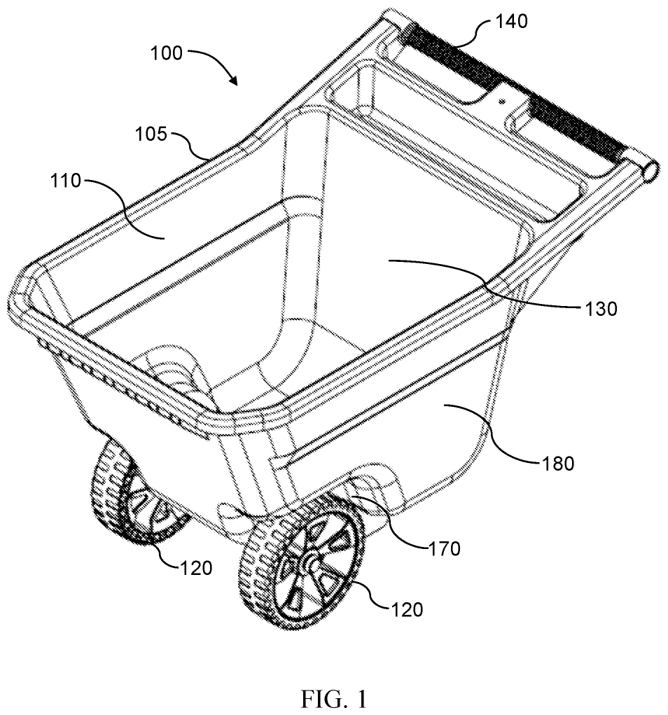

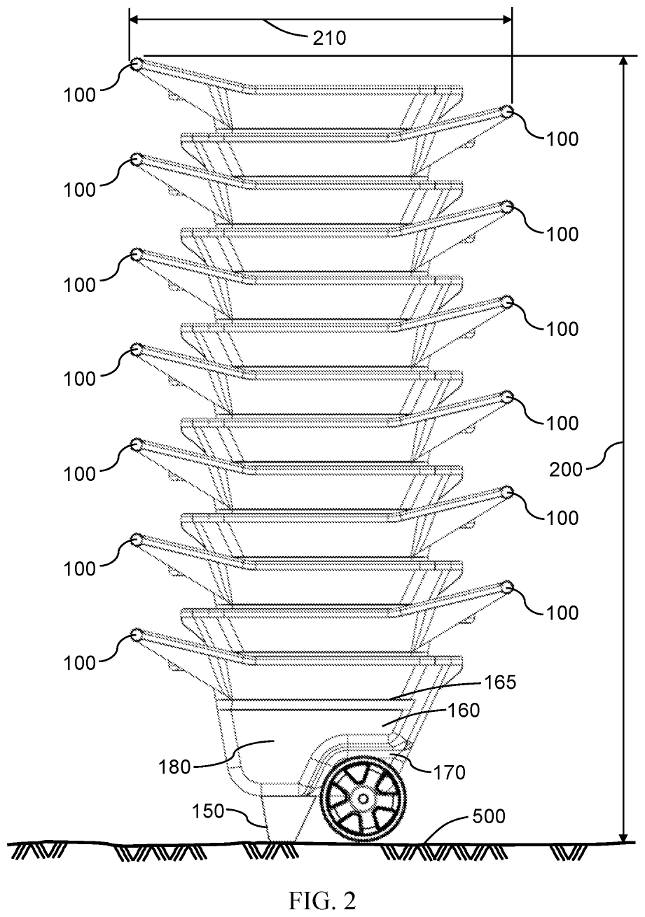

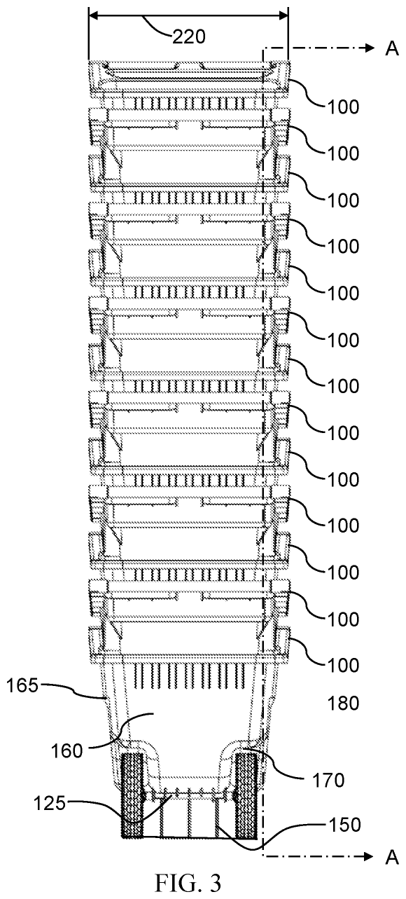

Referring to FIGS. 1-4, a stackable cart 100 is depicted in accordance with an embodiment of the disclosure. The stackable cart 100 is configured to allow the stackable cart 100 to be nested within another stackable cart 100 such as shown in FIGS. 2-3.

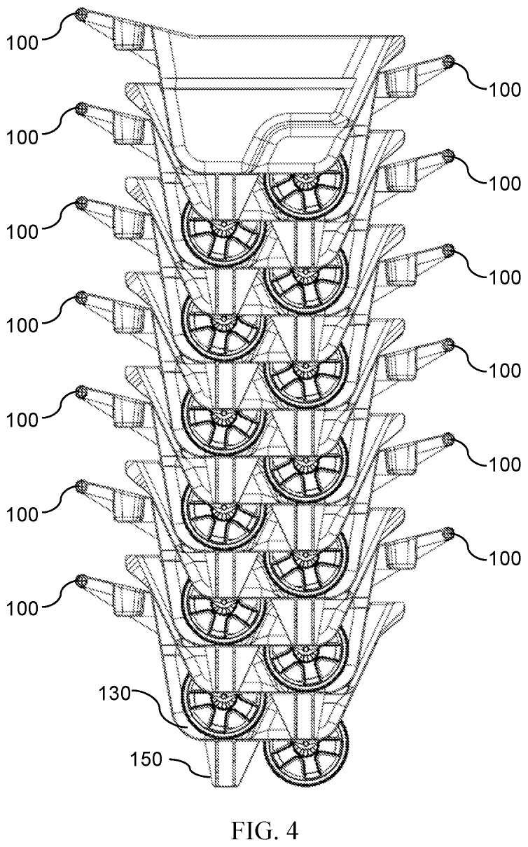

The stackable cart 100 includes a tub 110, a plurality of wheels 120, and a handle 140. The wheels 120 of the stackable cart 100 are preferable connected by an axle 125, but can also be individually attached to the tub 110. The tub 110 has a stand 150 with a lowermost extremity that is level with the lowest part of the wheels 120. This arrangement allows the stackable cart 100 to be level with a round surface 500 when in a resting position. The tub 110 includes a wheel cutout 170 for each wheel 120 that allows the wheels 120 to fit within the profile of the tub 110 and not extend to the outside wall 180 of the tub 110. The wheel cutouts 170 are sized to allow the stand 150 of one stackable cart 100 to fit between the wheel cutouts 170 of another stackable cart 100 into which the stackable cart 100 is to be nested (see FIG. 4).

The interior volume 130 of the tub 110 of the stackable cart 100 is dimensionally sized to accept the lower portion 160 of a second stackable cart 100 nested within it. The lower portion 160 of the stackable cart 100 is defined as the portion of stackable cart 100 below the tub shoulder 165. The tub 110 of the stackable cart 100 includes an upper tub edge 105 that runs around the upper perimeter of the tub 110.

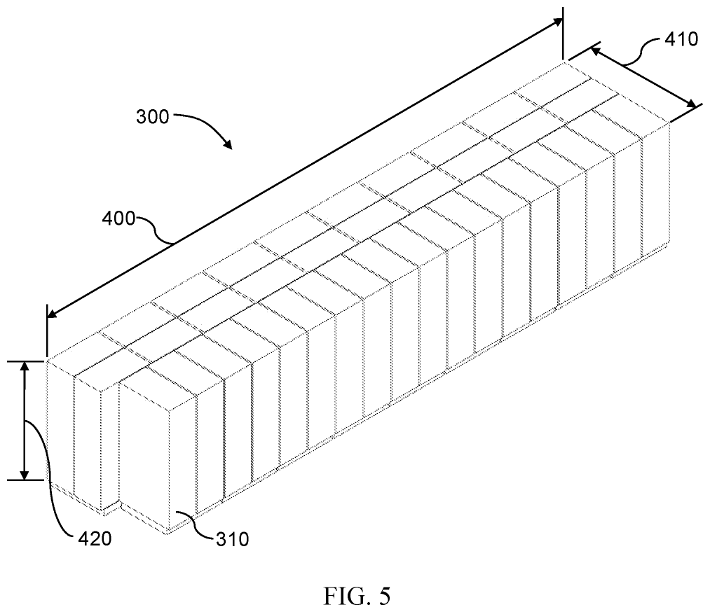

A significant advantage of the stackable cart 100 over prior art carts is the ability to stack the carts in a vertical manner by nesting a stackable cart 100 within a second stackable cart and then nesting those stackable carts 100 within another stackable cart. As seen in FIG. 5, the optimal arrangement 300 minimizes the volume of multiple stackable carts 100 to lessen the cost of transport and storage of the stackable cart 100. The arrangement allows for 13 stackable carts to be nested to have a height 420 that fits within the interior height of a standard 40-foot shipping container (7′ 10″).

The stackable cart 100 has a length 210 and width 220 such that 38 stacks 310 of 13 stackable carts 100 can fit within the interior of a standard 40-foot shipping container. FIG. 5 provides the arrangement of stacks 310 that will allow 494 stackable carts to fit within a standard shipping container with a width 410 not to exceed 7′ 6″ and a length 400 not to exceed 39′ 6″.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A stackable cart into which a second stackable cart can be nested, comprising:
a tub, the tub having an interior volume, a pair of wheel insets, and a stand;
a pair of wheels rotatably connected to the tub;
a handle operably connected to the tub;
wherein the interior volume is configured to receive a pair of wheels, a pair of wheel insets, and a stand of the second stackable cart within the interior volume when the second stackable cart is nested within the stackable cart; and
each wheel inset is configured to receive the entirety of a respective one of the pair of wheels and to receive the stand of the second stackable cart when the second stackable cart is nested within the stackable cart.

2. The stackable cart of claim 1, further comprising a tub shoulder, wherein the pair of wheels, pair of wheel insets, and the stand of the second stackable cart rest below the tub shoulder when the second stackable cart is nested within the stackable cart.

3. The stackable cart of claim 2, further comprising a tub upper edge, wherein the tub upper edge rests below a tub shoulder of the second stackable cart when the second stackable cart is nested within the stackable cart.

4. The stackable cart of claim 1 wherein the tub, handle, and stand are a unibody construction.

5. The stackable cart of claim 1 wherein the tub interior volume is greater than four cubic feet.

6. The stackable cart of claim 1 wherein the total height of 13 stackable sequentially nested is less than 96 inches.

7. The stackable cart of claim 5 wherein 494 stackable carts fit within a standard 40-foot shipping container.

8. The stackable cart of claim 1, further comprising an upper tub edge, wherein the stand and wheels both contact a ground surface upon which the stackable tub rests and the upper tub edge is parallel with a ground surface upon which the stackable cart rests.

9. The stackable cart of claim 1, further comprising a front profile, wherein the wheels are arranged within the front profile.

10. The stackable cart of claim 4, further comprising a tub upper edge, wherein the tub upper edge rests below a tub shoulder of the second stackable cart when the second stackable cart is nested within the stackable cart.

11. A stackable cart into which second stackable cart can be nested, comprising:
a tub, the tub having an interior volume, a pair of wheel insets, and a stand;
a pair of wheels rotatably connected to the tub;
a handle operably connected to the tub;
wherein the interior volume is configured to receive a pair of wheels and a stand of the second stackable cart within the interior volume and the wheel insets are configured to receive the stand of the second stackable cart when the second stackable cart is nested within the stackable cart.

12. The stackable cart of claim 11, further comprising a tub shoulder, wherein the pair of wheels, pair of wheel insets, and the stand of the second stackable cart rest below the tub shoulder when the second stackable cart is nested within the stackable cart.

13. The stackable cart of claim 12, further comprising a tub upper edge, wherein the tub upper edge rests below a tub shoulder of the second stackable cart when the second stackable cart is nested within the stackable cart.

14. The stackable cart of claim 14 wherein the tub, handle, and stand are a unibody construction.

15. The stackable cart of claim 15 wherein the tub interior volume is greater than four cubic feet.

16. The stackable cart of claim 16 wherein the total height of 13 stackable sequentially nested is less than 96 inches.

17. The stackable cart of claim 15 wherein 494 stackable carts fit within a standard 40-foot shipping container.

18. The stackable cart of claim 18, further comprising an upper tub edge, wherein the stand and wheels both contact a ground surface upon which the stackable tub rests and the upper tub edge is parallel with a ground surface upon which the stackable cart rests.

19. The stackable cart of claim 19, further comprising a front profile, wherein the wheels are arranged within the front profile.

20. The stackable cart of claim 14, further comprising a tub upper edge, wherein the tub upper edge rests below a tub shoulder of the second stackable cart when the second stackable cart is nested within the stackable cart.
